(19) United States
(12) Patent Application Publication
(10) Pub. No.: US 2005/0198069 A1
(43) Pub. Date: Sep. 8, 2005

(54) Meta-data association

(76) Inventors: Darrel D. Cherry, Boise, ID (US); James E. Clough, Meridian, ID (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/794,222

(22) Filed: Mar. 5, 2004

(51) Int. Cl. G06F 15/00

(52) U.S. Cl. 707/104.1

(57) ABSTRACT

Systems, methods and devices for associating meta-data to a received job are provided. One method includes detecting the job request at an agent on a source device. The method further includes identifying the source device and a type of the job request. Meta-data is associated with the job request at the agent on the source device based on an identity of the source device and the type of the job request.

In an information processing system, a particular job request such as a print job can be transferred over a network such as a local area network (LAN), wide area network (WAN), wireless network, or otherwise. Descriptive information can be included with the transmission of a print job request, but in public settings generally includes limited information such as a source, e.g., laptop computer, desktop computer, of the print job.

Meta-data can sometimes be used to provide descriptive information. Meta-data is defined as data that describes other data. The term may refer to detailed compilations such as data dictionaries and repositories that provide a fair amount of information about each data element. It may also refer to any descriptive item about data, such as the content of an HTML meta tag or a title field in a media file. Data dictionaries include a database about data and databases. A data dictionary holds the name, type, range of values, source, and authorization for access for each data element in an organization's files and databases. It also indicates which application programs use that data so that when a change in a data structure is contemplated, a list of affected programs can be generated. The data dictionary may be a stand-alone system or an integral part of a database management system (DBMS). For example, meta-data can include descriptive characteristics about data, such as the content of a job request, information, instructions, commands, and/or code that can be included with and/or provided to the job request.

Meta-data is generally added at the source device (e.g., a laptop computer) from which the job is requested. Thus, any changes to the meta-data (e.g., updating the meta-data) would involve accessing each device individually. This can be a time consuming process. Moreover, job requests transmitted in a public setting generally do not include a robust set of descriptive information.

For example, one public setting example includes a hotel where a guest may connect a laptop computer to a hotel network and send print jobs to a hotel printing center. Another public setting example includes a coffee shop where a visitor may connect a laptop to a wireless network connection offered by the coffee shop, e.g., to obtain internet access. In these public setting examples a job request, e.g., print job and/or internet access request will likely include just source information for the job request.

### BRIEF DESCRIPTION OF THE DRAWINGS

FIG. 1 illustrates an exemplary information processing system.

FIG. 2 illustrates another exemplary information processing system.

FIG. 3 illustrates a method embodiment for associating meta-data with a job request.

FIG. 4 illustrates another method embodiment for associating meta-data with a job request.

FIG. 5 illustrates an exemplary network in which embodiments of the invention may be practiced.

### DETAILED DESCRIPTION

Embodiments disclosed herein include methods, devices, and systems for associating meta-data with a job request at an agent on computing device based on identifying a source and a type of the job request. Embodiments further include updating meta-data to be associated with particular job requests at an agent of the source device from a recipient device over a network. Further embodiments allow for the meta-data to be associated with a job request at a source device and/or a recipient device as part of a spooling process using an agent on the source device and/or on the recipient device.

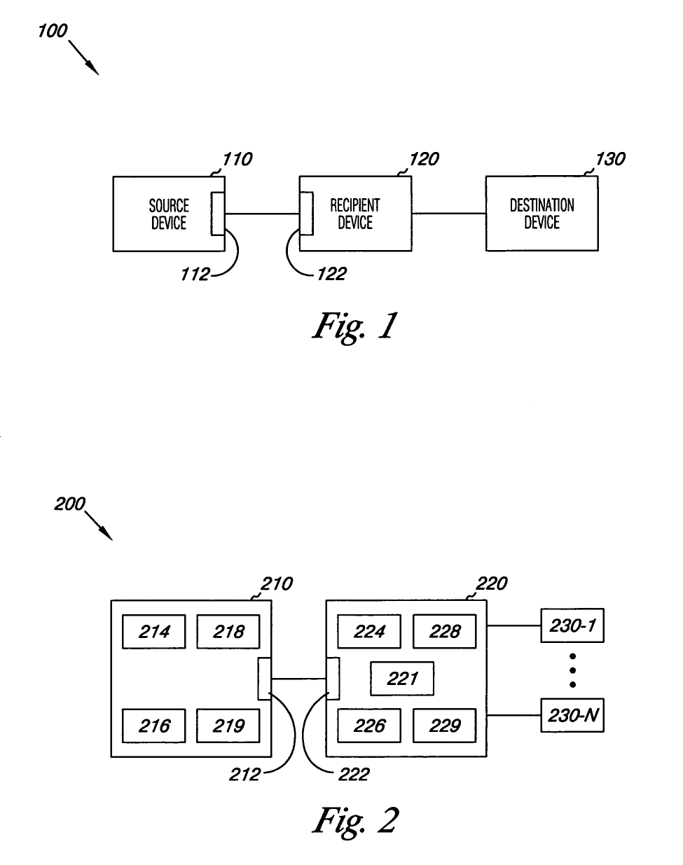

FIG. 1 provides an embodiment of an information processing system 100 of the present invention. The system 100 embodiment of FIG. 1 illustrates a source device 110, a recipient device 120, and a destination device 130 connected to one another over a network. Each of these devices can include processor and memory resources. That is, as one of ordinary skill in the art will appreciate upon reading this disclosure, memory can include software and firmware (e.g., computer executable instructions), executable to allow the source device 110 to connect and communicate with the recipient device 120 as well as for a recipient device 120 to connect and communicate with a destination device 130 and/or the source device 110. The system 100 can be configured such that communication between the source device 110, the recipient device 120, and the destination device 130 can be carried out using a wireless system, a wired system, or a combination of a wired and wireless system, e.g., Ethernet, local area network (LAN), wireless local area network (WLAN), a wide area network, (WAN), or otherwise.

By way of example and not by way of limitation, the source device 110 can include a personal computer, a handheld computer such as personal data assistant (PDA), a cellular phone having text and image data communication abilities, or other device of the like. The recipient device 120 can include a server or other network management station, and the destination device 130 can include a computing device for performing particular functions or tasks, e.g., accessing the internet, printing, accounting and billing functions, etc., as may be handled by print servers, accounting modules, Internet portals, and the like. As one of ordinary skill in the art will appreciate upon reading this disclosure, various program applications are executable on the devices described above.

According to embodiments of the present invention, program embodiments are provided to an agent 112 on the source device 110. The program embodiments can be provided to the agent 112 in the form of software and/or firmware. The program embodiments execute, upon detecting a job request, to associate an appropriate set of meta-data to the job request based on identifying the source device on a network and on the type of job request. One of ordinary skill in the art will appreciate the manner in which a source device 110 can be identified upon connecting to a network, e.g., mapped to a network management station and/or server. For example, when a laptop (e.g., source device 110) is connected to a network (e.g., LAN, WAN, wireless access point or otherwise) the laptop can communicate with a network management station (e.g., recipient device 120) to identify itself and be appropriately mapped in the network.

According to various embodiments the program embodiments provided to the agent 112 can be downloaded to the agent 112 over the network, previously installed on the source device 110 from a computer readable medium, e.g., CD, and/or downloaded thereto from the Internet. The program embodiments include instructions which can execute to associate various meta-data information with a job request according to various program application types, e.g., program applications to launch of a web browser, an email application, and/or a word processing program application.

In various embodiments, the program instructions execute with the agent 112 to associate the meta-data to a job request as part of a spooling process on the source device 110 and/or the recipient device 120. As one of ordinary skill in the art will appreciate, spooling (e.g., simultaneous peripheral operations online) involves the overlapping of low-speed operations with normal processing. Spooling originated with mainframes in order to optimize slow operations such as reading cards and printing. Originally, card input was read onto disk and printer output was stored on disk. In that way, the actual business data processing was done at high speed, since all I/O was on disk. Today, spooling is used to buffer data for the printer as well as remote batch terminals.

As shown in the embodiment of FIG. 1, the recipient device 120 can further include an agent 122. As will be explained in more detail below, the agent 122 on the recipient device can include an application program interface (API) implemented as function calls appropriate for interpreting meta-data received with a job request from the source device 110. Further, program embodiments provided to the agent 122 on the recipient device can execute instructions to update, e.g., modify, add, and/or delete, meta-data on the agent 112 of the source device 110. According to various embodiments the program embodiments provided to the agent 122 can be downloaded to the agent 122 over the network, previously installed on the recipient device 120 from a computer readable medium, e.g., CD, and/or downloaded thereto from the Internet. Additionally, as explained in more detail below, program instructions provided to the recipient device 120 can respond to a particular job request and initiate instructions to route the job request to a particular destination device 130 as the same has been described above. In some embodiments, the destination device 130 and the recipient device 120 can be one in the same.

FIG. 2 illustrates another embodiment of an information processing system 200. The system 200 can include computer executable instructions executed on one or more devices in a network, e.g., LAN, WAN, wired and/or wireless, etc. The system embodiment in FIG. 2 illustrates a source device 210 and a recipient device 220, which can include devices such as those described above, connected over a network. In the embodiment of FIG. 2, the recipient device 220 is illustrated connected in the network to a number of possible destination devices 230-1 through 230-N. The designator “N” is intended to indicate that a number of different destination devices can be coupled to the recipient device 220. The destination devices, 230-1 through 230-N, can include printers, facsimile machines, internet portals, and/or devices controlling access to other computing devices on the network, e.g., DVD players, long distance access, etc.

As shown in the embodiment of FIG. 2, the source device 210 includes an agent 212 as the same has been described above in connection with FIG. 1. The embodiment of FIG. 2 further illustrates the source device 210 includes a processor 214 and a memory 216 resource. As identified above, the memory 216 can include a number of program applications, e.g., web browsers, email utilities, word processing programs and the like, having instructions executable by the processor 214. The source device 210 can include other components such as an I/O device 218 and a display device 219, as the same are known to those of ordinary skill in the art. The I/O device 218 can include a keyboard, a mouse, a data port, a speaker, a microphone, etc. and the display device 219 can include a flat, touch panel display, for example. Program application instructions can be stored on memory 216 and operated on by the processor 214 to execute a number of different job request types, e.g., to send a fax, to send a print job, to access email and/or the Internet, to play a movie from a remote movie library, etc. As described in connection with FIG. 1, the agent 212 includes program embodiments which execute to identify a source device and a type of job request. The agent 212 on the source device 210 includes program instructions to further process the job request and associate meta-data with the job request based on an identity of the source device and the type of job request. The identity of the source device 210 can include information retrieved from the memory 216 of the source device 210, information entered by a user of the source device 210, and/or information retrieved from connection to the network, e.g., can include location information provided to the source device 210 determined based on where the source device 210 has connected to the network. Embodiments, however, are not limited to these examples. Information on the type of job request can include information retrieved from the application program being executed by the source device 210.

As shown in the embodiment of FIG. 2, the recipient device 220 includes an agent 222, as the same has been described above in connection with FIG. 1, coupled over the network 200 to the source device 210 to receive job request information and associated meta-data from the source device 210. The embodiment of FIG. 2 further illustrates the recipient device 220 includes a processor 224 and a memory 226 resource. As identified above, the memory 226 can include a number of program applications having instructions executable by the processor 224. By way of example and not by way of limitation, the program applications on the recipient device 222 can include applications for managing data traffic over the network, including receiving, interpreting, and routing, etc. job requests received from the source device 210. The recipient device 220 can likewise include other components such as an I/O device 228 and a display device 229, as the same have been described above. Program application instructions can be stored on memory 226 and executable by the processor 214 to operate on the number of different job request types, e.g., fax requests, print requests, email and/or the Internet access requests, movie requests, etc.

According to the various embodiments, the agent 222 on the recipient device 220 includes program instructions which execute to process identity information received from the source device 210, provide location information, provide updated meta-data information to the agent 212 on the source device, and/or to associate additional meta-data with the job request. For example, the program embodiments provided to the agent 222 can execute instructions to associate additional meta-data with the job request before further processing of the job request. In this manner, the meta-data associated with particular source device 210 identities and job requests types can be changed and/or added from various locations on a network, including a central location such as the network management station, e.g. recipient device 220. As one example, the I/O device 228 of the recipient device 220 can be used to change, add, and/or delete meta-data in association with any number of different source device 210 identities and job request types. In various embodiments the program instructions can execute to modify, add, and/or remove meta-data in association with particular job requests and source device identities as they are received at the recipient device 220. In various embodiments the program instructions can execute to modify, add, and/or remove meta-data to be associated with particular job requests and source device identities by transmitting such changes to a particular source device 210 and/or group, class, etc. of source devices connected to the recipient device 220 over the network.

Since the meta-data is associated with a particular source device identity and a particular job type request, the meta-data can be dynamically tailored to various users on the network 200. For example, the particular meta-data may be selectably tailored to associate certain billing information with a particular job request type, e.g., fax request, movie request, internet access request, print request, etc., and be selectably tailored to particular users. Thus, by way of example and not by way of limitation, all source devices at a particular location which transmit a movie job request may be charged according to a certain pricing schedule while all source devices at another particular location which transmit the same movie job request may be charged according to a different pricing schedule. And, source devices at the same or different locations can similarly be charged differently according to different job request types. Additionally, however, source devices at the same location and transmitting the same job request type can additionally be differentiated, e.g., charged according to different pricing schedules, by attaching different meta-data newly received over the network or already present on the particular source device 210 due to a uniqueness of the source device identity. Embodiments, however, are not limited to these examples. According to various program embodiments, meta-data can be dynamically associated to particular job types and source device identities by a source device agent 212 and/or a recipient device agent 222 as part of a software spooling process.

As shown in the embodiment of FIG. 2, the recipient device further includes an application programming interface (API) 221. The API 221 can receive and interpret the job request and the associated meta-data, whether associated from agent 212 at the source device 210 or the agent 222 at the recipient device 220, or from both. As one of ordinary skill in the art will appreciate the API 221 provides the language and message format used by an application program, as the same have been described above, to communicate with the operating system or some other control program on the recipient device 220. The API 221 is used to execute instructions for recognizing meta-data commands associated with job requests, whether associated from agent 212 at the source device 210 or the agent 222 at the recipient device 220, or from both. In the various embodiments, function calls for implementing the API 221 can be stored with one or more program applications on memory 226 of the recipient device 220 or retrieved from elsewhere in the network 200, e.g., another storage media. As used herein, a function call can be a software routine to perform a task such as instructing the operating system of the recipient device 220 to print a job request and to bill a source device 210 particular to a job request and its associated meta-data. Thus, in various embodiments, as meta-data are updated, modified, added, deleted, etc., the function calls for the API 221 can be programmed to recognize the meta-data and thus, function calls can implement the updated API's such that the operating system of the recipient device 220 can execute the function call.

As the job requests and associated meta-data are received by the recipient device 220 and processed using the agent 222 and appropriate API 221, the recipient device can execute instructions to route the various types of job requests to an appropriate destination device, e.g., 230-1 through 230-N. Additionally, as will be discussed in more detail below, by using the meta-data the program embodiments can execute instructions which transmit an output to a source device 210 which is off some form of interest to a user of the source device 210.

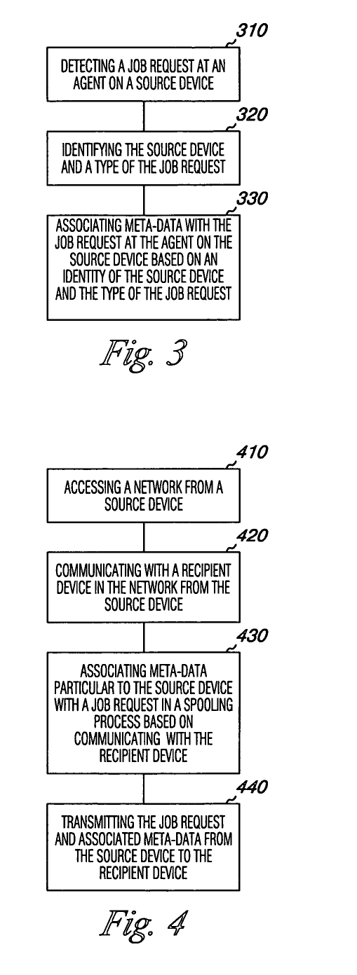

FIGS. 3 and 4 illustrate various method embodiments to associate meta-data with a job request. As one of ordinary skill in the art will understand, the embodiments can be performed by computer executable instructions operable on the systems and devices shown herein or otherwise. The invention, however, is not limited to a particular operating environment or to software written in a particular programming language. Computer executable instructions, including software, program applications, and/or application modules, suitable for carrying out embodiments of the present invention, can be resident in one or more devices or locations or in several locations in a distributed computing environment.

Unless explicitly stated, the method embodiments described herein are not constrained to a particular order or sequence. Additionally, some of the described method embodiments can occur or be performed at the same point in time.

FIG. 3 illustrates a method for associating meta-data to a job request. As shown in the embodiment of FIG. 3, the method includes detecting a job request at an agent on a source device in block 310. As described above, source devices can include, but are not limited to, laptop computers, handheld computers such as personal data assistants, and cellular phones having text and image data communication abilities, etc. Such devices generally include processor and memory resources. The memory can store a number of program applications, such as web browser applications, word processing applications, email utilities, etc., and the program applications can be executed by the processor. As described above in connection with FIG. 2, the agent on the source device includes program embodiments which execute to detect a job request.

As shown in block 320, the method further includes identifying the source device and a type of job request. Program embodiments are provided to an agent of the source device which execute to identify the source device and the type of job request. As described above, the program embodiments can execute to identify an identity of the source device from information retrieved from a memory of the source device, information entered by a user of the source device (e.g., user. ID and/or password), as well as information retrieved from connection to the network (e.g., can include location information provided to the source device 210 determined based on where the source device has connected to the network). Embodiments, however, are not limited to these examples. Information on the type of job request can include information retrieved from the application program being executed by the source device. By way of example and not by way of limitation, examples of a type of job request include requests for printing documents, sending and receiving facsimiles and/or emails, accessing the Internet, playing movies from a video library, and the like.

As shown in block 330 the method further includes associating meta-data with the job request at the agent on the source device based on an identity of the source device and the type of the job request. As described above, program embodiments are provided to the agent on the source device which execute to associate the meta-data to the job request based on the identity of the source device and the type of the job request. In various embodiments, the program instructions execute to associate the meta-data with the job request as part of a spooling process on the source device.

As one will appreciate from the discussion in FIG. 2, the meta-data used by the agent on the source device can include meta-data transmitted to the agent on the source device from an agent on a recipient device connected to the source device over a network. For example, the recipient device can include a network management station having an agent provided with program embodiments which execute to add, delete, and/or modify meta-data to be associated with particular job requests from particular source devices on the network. The agent on the recipient device can include program embodiments which execute to process the job request and associated meta-data in conjunction with an application program interface once received from the source device. The recipient device can further include program applications which execute to transmit the job request and associated meta-data to an appropriate destination device. The agent on the recipient device can, in various embodiments, associate meta-data to the job request before transmitting the job request and associated meta-data to the appropriate destination device. As above, in various embodiments the program instructions execute to associate the meta-data with the job request as part of a spooling process on the recipient device.

By way of example, and not by way of limitation, a source device, e.g., laptop, including an agent having the program embodiments described herein, can be connect to a hotel network through a data port in a users hotel room. The hotel computer network can include a recipient device and other destination devices. The recipient device can be a hotel server, a network management station, etc., connected over a LAN, WAN, etc. Examples of the destination device can include, but are not limited to, printers, facsimile machines, internet portals, other computing devices on the hotel network, and so forth. These destination devices may enable a user connected to the network to access, for example, printing services, facsimile services, Internet and email services, and movie services, among other services provided through the hotel network.

To connect to the hotel network a user can log on (e.g., provide a user ID, password, room number, etc.), or additionally the program embodiments described herein can execute instructions such that when the laptop is connected to the data port in the hotel room this information is retrieved from information collected from the user when the user “checked-in” to the hotel and which was stored in the hotel network management station. As described above, one of ordinary skill in the art will appreciate the manner in which a device connected to a network (in a wired and/or wireless fashion) can be mapped and its location recorded upon connecting to the network through the execution of network management software.

As described above, the user's laptop can contain a number of different program application types, e.g., web browser applications, word processing applications, email utilities, etc. And, such various application types can initiate various job requests, e.g., requests for printing documents, sending and receiving facsimiles and/or emails, accessing the Internet, playing movies from a video library, and the like.

According to the embodiments, once the agent has detected a job request and identified the source device, e.g., location (room number) and/or user information, the program embodiments can execute to associate meta-data with the job request which is particular to the type of job request and the source device identity. For example, if the user of the source device is identified as a preferred guest of the hotel, or the source device is connected to the hotel network from a hotel room which is a preferred suite, then the meta-data which is associated with the job request can include information to provide a discount from the charges normally associated with the particular job request. For example, the job request may include a request to play a movie from a movie server connected to the hotel network. The hotel may charge hotel guests according to one pricing schedule for guest staying in certain rooms or on certain floors and charge hotel guests according to a different pricing schedule for preferred guest, e.g., staying in particular rooms or on a particular floor.

In this example, the meta data associated with the job request to play a movie can be processed by program embodiments executing on an agent of the hotel network management station in conjunction with an appropriate API in order to accord the guest a discount on their movie billing. That is, program embodiments executing on the agent of the recipient device can both transmit appropriate billing information to the hotel's accounting software, as one destination device, and can execute instructions to retrieve a movie from a movie library, e.g., a movie server as another destination device, and transmit the movie for viewing as an output back to the source device. One of ordinary skill in the art will appreciate manners in which a similar treatment can occur for email and/or Internet access requests, printing requests, requests to access long distance service, requests to send and receive facsimiles, and the like. Embodiments are not limited to the presented examples.

As another example, once the user is connected to the network and the program embodiments executing on the agent have identified the type of the job request and identified the source device, e.g., location and/or user information, the program embodiments can execute to associate meta-data with the job request as appropriate to the particular type of job request and the source identity. For example, if the type of job request is for printing and facsimile services, then the meta-data which is associated with the job request can include information relating to the volume and frequency of the requests and can include information to charge a discount from the charges normally associated with the particular job request. Again, if the hotel guest is a preferred guest the meta-data associated with the job request may include additional discounts regardless of the volume and frequency of the requests.

In this example, the meta data associated with the job request for printing and facsimile services can be processed by program embodiments executing on an agent of the hotel network management station in conjunction with an appropriate API in order to accord the guest a discount on the volume and frequency of their job requests or based on identifying a particular hotel room (where the source device is connected to the network) as one occupied by a preferred guest. For example, in processing the job requests program embodiments executing on the agent of the recipient device can both transmit appropriate billing information to the hotel's accounting software, as one destination device, and can execute instructions to execute the printing and facsimile job requests on printers and facsimile machines connected to the hotel network, e.g., through a print and facsimile server, as another destination device. The program embodiments may even execute to transmit incoming, received facsimiles as an output directly back to the source device for viewing thereon and/or printing in the hotel room.

As yet another example, once the user is connected to the network and the program embodiments executing on the agent have identified the source device, e.g., location and/or user information, the program embodiments can execute to associate meta-data with transmission from the agent on the hotel's network management station to the agent on the source device. This meta-data information can include notices and/or advertising and marketing for items of potential interest to the user of the source device. For example, the meta-data information may be transmitted to the hotel guest in connection with a print job request inviting the user to visit the hotel's business center, advertising the hotel's conference facilities, and/or solicit that the guest visit the hotel's restaurant or lounge, announce performers or meetings in the hotel, salon and gift shop services, and even provide coupons or discount offers for participating in the offered services and activities. Likewise, program embodiments executing on an agent of the hotel network management station may identify that the guest enjoys spending time in the hotel's casino and accordingly transmit meta-data information to the source device offering the user of the source device free tokens accepted in the casino and/or otherwise encourage the guest to visit the same. Again, one of ordinary skill in the art will appreciate various manners in which a similar treatment for email and/or Internet access requests, printing requests, requests to access long distance service, requests to send and receive facsimiles, and the like can occur or be afforded to the guest based on identifying the source device and a type of the job request. Embodiments are not limited to the presented examples.

While the forgoing illustrations of various embodiments of the present invention have discussed a hotel setting, it will be appreciated that the embodiments of the present invention can be carried out in any number of additional settings and/or networks. For example, embodiments of the present invention may be carried out in “internet cafés”, wireless internet zones, including those in restaurants, airports, and shopping areas, to name a few.

FIG. 4 illustrates another method embodiment for associating meta-data with a job request. As shown in the embodiment of FIG. 4, the method includes accessing a network from a source device at block 410. Accessing a network can be performed in any suitable manner, wired or wirelessly, such has been described above. In block 420, the method further includes communicating with a recipient device in the network from the source device. As described above, the recipient device can include a network server or other management station in the network having executable network management instructions to map the source device to the recipient device. The recipient device can contain information relating to a user of the source device, e.g., based on program embodiments executing on an agent of the source device to transmit this information to the recipient device and/or based on previous information stored on the recipient device from previous network connections or as data entered by another individual associated with other network program applications or administration, e.g., a receptionist at the “check-in” counter.

In this example embodiment, communicating with the recipient device includes receiving meta-data updates transmitted from program instructions executing on an agent of the recipient device. For example, based on information known about the user of the source device, interests, demographics, etc., the program embodiments on the agent of the recipient device can execute to transmit modifications, additions, and/or deletions to the meta-data on an agent of the source device. As one of ordinary skill in the art will appreciate upon reading this disclosure, this approach allows adjustments to meta-data to be attached to job requests without having to enter such meta-data changes at the physical location of each individual source device.

From the examples, above, one will appreciate that modification to the types of meta-data associated with various job requests can be due to a number of reasons. For instance, in the hotel example given above a guest may be visiting the hotel during a certain promotion, season, or have previously stayed at the hotel a prerequisite number of times to be afforded certain discounts or privileges. Alternatively, the hotel may elect to alter the pricing schedule charged to guests of various classes, and to job requests of various types, due to economic changes or otherwise. According to embodiments of the present invention, any one or more types of the above described meta-data can be updated and transmitted from program instructions executing on an agent of the recipient device.

In block 430, the method includes associating meta-data particular to the source device with a job request based on communicating with the recipient device. As illustrated in this embodiment, the meta-data is associated with the job request in a spooling process. Embodiments, however, are not so limited. As described above, various types of meta-data information can be associated with a particular type of job request from a particular identified source device based on information known about the user of the source device, interests, demographics, etc. As shown in block 440, the method further includes transmitting the job request and associated meta-data from the source device to the recipient device. Program embodiments executing on an agent of the recipient device can operate to process the job request and associated meta-data accordingly, e.g., as described in the examples above. Further, as described above, program embodiments can execute on the agent of the recipient device to transmit the job request and associated meta-data to one or more destination devices and can execute to output information and/or services back to the source device based on such processing.

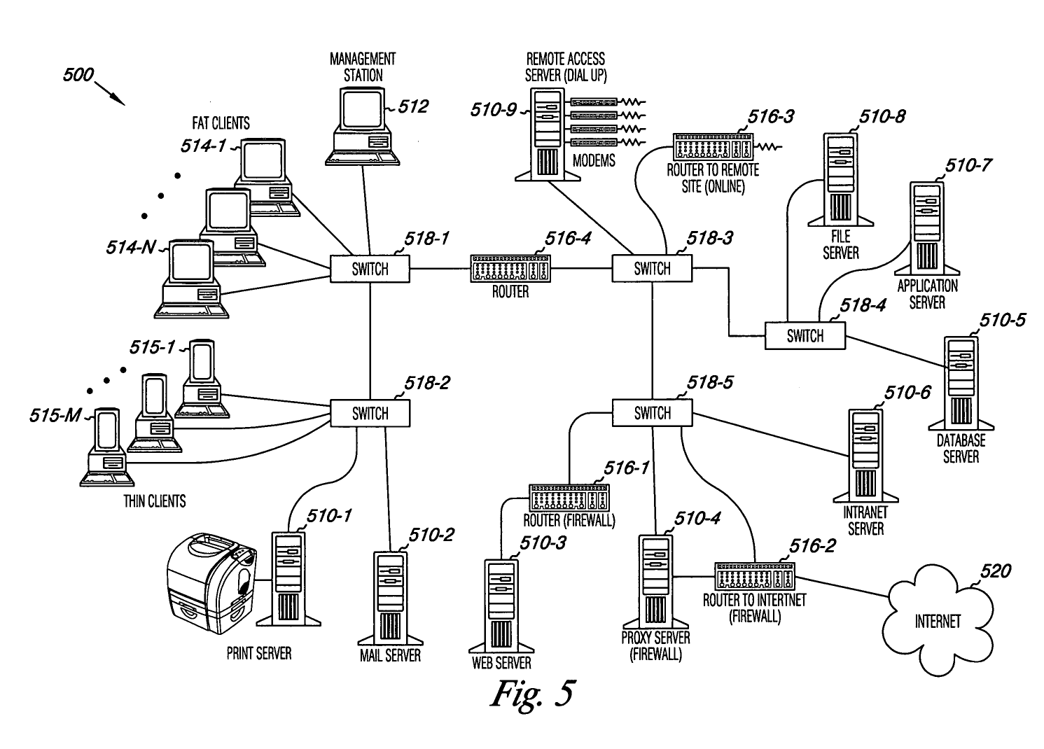

FIG. 5 is illustrates a network of various computing devices 500. FIG. 5 illustrates an exemplary network in which embodiments of the invention may be practiced. As illustrated in FIG. 5 a number devices can be networked together via a LAN and/or WAN via routers, hubs, switches and the like. The embodiment of FIG. 5 illustrates clients and servers in a LAN. However, embodiments of the invention are not so limited. The embodiment shows one server for each type of service on a LAN. However, in practice several functions can be combined in one device or machine and, for large volumes, multiple devices or machines can be used to balance the traffic for the same service. For example, an enterprise system or network can include a collection of servers, or server farm, cooperating to provide services to the network.

FIG. 5 illustrates a print server 510-1 to handle print jobs for the network 500, a mail server 510-2, a web server 510-3, a proxy server (firewall), a database server 510-5, and intranet server 510-6, an application server 510-7, a file server 510-8, and a remote access server (dial up) 510-9. Any one or more of these devices can serve as a destination device as described in the above embodiments. The examples provided here, however, do not provide and exhaustive list. The network shown in FIG. 5 further illustrates a network management station 512, e.g., a PC or workstation. As one of ordinary skill in the art will appreciate from reading this disclosure, such a network management station 512 can serve as a recipient device as described in the above embodiments.

The network shown in FIG. 5 further illustrates a number of “fat” clients, 114-1, . . . , 114-N which can also include PCs and workstations and/or laptops, and a number of “thin” clients 115-1, . . . , 115-M which can include terminals and/or peripherals such as scanners, facsimile devices, handheld multifunction devices, and the like. The designators “N” and “M” are used to indicate that a number of fat or thin clients can be attached to the network 100. The number that N represents can be the same or different from the number represented by M. One of ordinary skill in the art will appreciate that “thin” clients generally have fewer resources than fully-loaded Windows or Mac machines. One of ordinary skill in the art will appreciate upon reading this disclosure that any one or more of the number of “fat” clients, 114-1, . . . , 114-N and/or the number of “thin” clients 115-1, . . . , 115-M can serve as a source device as described in the above embodiments.

The embodiment of FIG. 5, illustrates that all of these illustrative devices can be connected to one another and/or to other networks via routers, 516-5, 516-2, 516-3, and 516-4, and hubs and/or switches 518-1, 518-2, 518-3, 518-4, and 518-5, as the same are known and understood by one of ordinary skill in the art. Embodiments of the invention, however, are not limited to the number and/or quantity of devices in FIG. 5's illustration.

Although specific embodiments have been illustrated and described herein, those of ordinary skill in the art will appreciate that any arrangement calculated to achieve the same techniques can be substituted for the specific embodiments shown. This disclosure is intended to cover any and all adaptations or variations of various embodiments of the invention.

It is to be understood that the above description has been made in an illustrative fashion, and not a restrictive one. Combination of the above embodiments, and other embodiments not specifically described herein will be apparent to those of skill in the art upon reviewing the above description. The scope of the various embodiments of the invention includes any other applications in which the above structures and methods are used. Therefore, the scope of various embodiments of the invention should be determined with reference to the appended claims, along with the full range of equivalents to which such claims are entitled.

In the foregoing Detailed Description, various features are grouped together in a single embodiment for the purpose of streamlining the disclosure. This method of disclosure is not to be interpreted as reflecting an intention that the embodiments of the invention require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separate embodiment.

1. A method for associating meta-data to a job request, comprising:
detecting the job request at an agent on a source device;
identifying the source device and a type of the job request; and
associating meta-data with the job request at the agent on the source device based on an identity of the source device and the type of the job request.

2. The method of claim 1, further including processing the meta-data in a spooler process on the source device, wherein processing includes:
receiving from a recipient device meta-data unique to the identity of the source device and the type of the job request; and
associating meta-data received form the recipient device with the job request.

3. The method of claim 1, further including transmitting the job request and associated meta-data from the source device to an agent on a recipient device for further processing.

4. The method of claim 3, wherein further processing includes associating additional meta-data with the job request.

5. The method of claim 3, wherein further processing includes transmitting the job request and associated meta-data to a destination device.

6. The method of claim 3, wherein further processing includes transmitting an output from the recipient device to the source device based on the job request and associated meta-data.

7. The method of claim 1, wherein the method includes providing at least one application program interface (API) to recognize meta-data associated with the job request.

8. The method of claim 1, wherein detecting the job request includes detecting a job request selected from the group of a print job request, a fax request, a movie request, a request to access email, and an internet access request.

9. The method of claim 1, further including updating meta-data at the agent on the source device from the recipient device.

10. A method of using meta-data, comprising:
accessing a network from a source device;
communicating with a recipient device in the network from the source device;
associating meta-data particular to the source device with a job request in a spooling process based on communicating with the recipient device; and
transmitting the job request and associated meta-data from the source device to the recipient device.

11. The method of claim 10, further including transmitting the job request and associated meta-data from an agent at the source device to an agent on the recipient device.

12. The method of claim 10, further including processing the job request and associated meta-data on the recipient device.

13. The method of claim 10, further including providing an application program interface (API) on the recipient device to interpret the meta-data.

14. The method of claim 10, further including associating meta-data selected from the group of:
billing information particular to the source device and a type of job request;
coupon and discount information particular to the source device and the type of job request; and
advertisement and related interest information particular to the source device and the type of job request.

15. The method of claim 10, further including transmitting the job request and associated meta-data from the recipient device to a destination device selected from the group of:
a print server;
a computing device for accounting and billing;
an email server;
an Internet portal;
a movie server; and
a long distance communication switch.

16. The method of claim 10, further including modifying meta-data at an agent on the recipient device and transmitting modified meta-data to an agent on the source device.

17. The method of claim 10, further including providing an output to the source device from the recipient device, the output selected from the group of:
a coupon for additional services;
an advertisement related a type of the job request; and
a notification bulletin.

18. A computer readable medium having a set of computer executable instructions thereon for causing a device to perform a method, the method comprising:
detecting the job request at an agent on a source device;
identifying the source device and a type of the job request; and
associating meta-data with the job request at the agent on the source device based on an identity of the source device and the type of the job request.

19. The medium of claim 18, wherein the method further includes transmitting the job request and associated meta-data from the agent on the source device to an agent on a recipient device.

20. The medium of claim 19, wherein the method further includes processing the job request and associated meta-data using an application program interface and the agent in the recipient device.

21. The medium of claim 20, wherein the method further includes transmitting the job request and associated meta-data to a destination device.

22. The medium of claim 20, wherein the method further includes associating additional meta-data with the job request on the recipient device before transmitting to the destination device.

23. The medium of claim 18, wherein the method further includes associating meta-data with the job request in a spooling process.

24. A computing device, comprising:
a processor;
a memory coupled to the processor; and
program instructions stored on the memory and executable by the processor to;
detect a job request at an agent on the computing device;
identify a source and a type of the job request; and
associate meta-data with the job request at the agent on the computing device based on an identity of the source and the type of the job request.

25. The computing device of claim 24, further including program instructions which execute to process the job request and associated meta-data and transmitting the job request and associated meta-data to a destination device.

26. The computing device of claim 24, wherein the source of the job request includes a source selected from the group of;
a personal computer;
a personal data assistant; and
a cell phone.

27. An information processing system, comprising:
a source device including computer executable instructions for creating a job request;
a recipient device coupled to the source device; and
means for associating meta-data with the job request based on an identity of the source device and a type of the job request.

28. The system of claim 27, wherein the means for associating meta-data with the job request includes a set of computer executable instructions provided to an agent on the source device.

29. The system of claim 28, wherein the agent includes program instructions which execute to:
detect the job request;
identify the source device and the type of the job request; and
associate the meta-data with the job request based on the identity of the source device and the type of the job request.

30. The system of claim 28, wherein the recipient device includes an agent having program instructions which can execute to modify meta-data associated with various job requests and can execute to transmit modified meta-data to the agent on the source device.

31. The system of claim 27, wherein the recipient device includes program instructions which can execute to process the job request and associated meta-data received from the source device and which can execute to associate meta-data to the job request.

32. The system of claim 27, wherein the recipient device includes an application program interface (API) which can execute instructions to interpret meta-data associated with received job requests.

33. The system of claim 27, wherein the recipient device includes program instructions which can execute to transmit the job request and associated meta-data to a destination device.

34. The system of claim 27, wherein the source device is coupled to the recipient device over a local area network.

35. The system of claim 27, wherein the source device is coupled to the recipient device over a wireless network.
